(19) United States
(12) Patent Application Publication
(10) Pub. No.: US 2026/0162488 A1
(43) Pub. Date: Jun. 11, 2026

(54) METHOD FOR A GAMING SYSTEM

(71) Applicant: Play'n Go Marks Ltd, Valletta (MT)

(72) Inventor: Miguel Angel Lazaro SOLANA, Valletta (MT)

(73) Assignee: Play'n Go Marks Ltd, Valletta (MT)

(21) Appl. No.: 19/180,454

(22) Filed: Apr. 16, 2025

(30) Foreign Application Priority Data
Apr. 18, 2024 (SE) 2450414-4

(51) Int. Cl. G07F 17/32

(52) U.S. Cl. CPC G07F 17/3225; G07F 17/3211; G07F 17/3288

(57) ABSTRACT

The present disclosure relates to a computer-implemented method performed by a gaming system. In particular, the present disclosure relates to a scheme for allowing enhanced capability of interacting in a fast-pacing game where real-time decisions are critical to the gameplay experience for ensuring security and integrity of the game. The present disclosure also relates to a corresponding gaming system and to a computer program product.

### CROSS-REFERENCE TO RELATED APPLICATIONS

This application claims priority to Swedish Patent Application No. 2450414-4, filed on April 18, 2024. The disclosure of the above application is hereby incorporated by reference in its entirety.

### TECHNICAL FIELD

The present disclosure relates to a computer-implemented method performed by a gaming system. In particular, the present disclosure relates to a scheme for allowing enhanced capability of interacting in a fast-pacing game where real-time decisions are critical to the gameplay experience for ensuring security and integrity of the game. The present disclosure also relates to a corresponding gaming system and to a computer program product.

### BACKGROUND

Games of chance, particularly online, have evolved significantly, continually adapting to technological advancements, and changing player expectations. Among the diverse formats that have gained popularity are crash games, a relatively recent innovation in the online gaming landscape. These games are characterized by their dynamic gameplay mechanics, where the potential winnings can multiply within a short timeframe, creating a thrilling experience for participants.

In the competitive gaming industry, there is a constant push to enhance player engagement and retention. This has led to the development of games that not only attract players but also maintain their interest through engaging and, at times, intense gaming experiences. The intensity of these games often comes from the ability to make rapid, real-time decisions that can significantly influence the outcome.

However, with the increasing complexity and pace of such games, maintaining the security and integrity of gaming interactions becomes paramount. Ensuring that all players have a fair and consistent gaming experience, especially in environments where game outcomes are highly volatile and can change swiftly, is a critical challenge. The industry has recognized the need to manage these games carefully to prevent exploitation and to ensure that the outcomes remain within controlled limits set by gaming operators.

Moreover, while the allure of high payouts is attractive to players, it is essential for operators to balance this with the risk management of their platforms. Such a balance is crucial not only to preserve the financial sustainability of the gaming operations but also to adhere to regulatory standards and ensure responsible gaming practices. Taking the above into account, there may be seen a need for further development focusing on a possibility of intensifying the gaming experience while simultaneously enhancing the security measures and ensuring the robust management of game dynamics and payouts.

### SUMMARY

According to an aspect of the present disclosure, the above is at least partly met by a computer-implemented method for operating an online game on a gaming system, the gaming system comprising a server configured for real-time communication with an electronic user device via a network connection, the electronic user device comprising a display screen provided with a graphical user interface (GUI), wherein the method comprises the steps of generating, by the server, a graphical gaming environment, wherein the graphical gaming environment comprises a visualization of a multiplication factor, and the multiplication factor is incrementally adjusted from a predefined start value over a duration of a game round, transmitting, by the server, information representing the graphical gaming environment to the electronic user device for rendering at the GUI of the electronic user device, receiving, by the server via the network connection, a first bet from a user of the electronic user device, wherein the first bet initiates participation in the game round within the generated graphical gaming environment, determining, continuously by the server, an intermediate gaming outcome based on the first bet and a current value of the incrementally adjusted multiplication factor, controlling, by the server, the GUI of the electronic user device to enable a user interaction portion within the GUI, receiving, by the server, a user-initiated request at the user interaction portion within the GUI of the electronic user device to collect the intermediate gaming outcome, maintaining, by the server, the visualization of the incrementally adjusted multiplication factor within the GUI of the electronic device following the collection of the intermediate gaming outcome, receiving, by the server, a user-initiated request at the user interaction portion within the GUI of the electronic user device to reenter the game round, wherein a second bet for reentry is determined based on a predefined criterion, receiving, by the server, a user-initiated request at the user interaction portion within the GUI of the electronic user device to collect a final gaming outcome, wherein the final gaming outcome is determined based on the second bet and the current value of the incrementally adjusted multiplication factor, and controlling, by the server, the GUI of the electronic user device to visually represent the final gaming outcome, wherein the user-initiated requests at GUI of the electronic user device are timestamped to associate the user-initiated requests with a corresponding value of the incrementally adjusted multiplication factor.

The operational scheme according to the present disclosure integrates real-time communication between a server and an electronic user device to facilitate an interactive online game. The responsibility of the server includes generating a dynamic gaming environment where a multiplication factor visually displayed to the user progressively adjusting from a set starting point throughout the game round. The multiplication factor can adjust by i) progressively increasing from a starting point, ii) progressively increasing and then decreasing from a starting point, or iii) progressively decrease and then increase from a starting point. The multiplication factor preferably adjusts by incrementally increasing from a starting point. The server not only manages the graphical representation of this factor but also processes all bets and decisions made by the user in real-time. These decisions involve entering the game by placing a first bet, opting to collect intermediate game outcomes, and reentering the game with a subsequent bet, all based on the prevailing value of the multiplication factor.

Within the context of the present disclosure, synchronization between the server and the electronic user device is implemented to ensure that user-initiated actions, such as reentry into an ongoing game round or collection of a gaming outcome, are accurately associated with the corresponding state of the game, specifically in relation to a current value of the incrementally adjusted multiplication factor. Accordingly, in accordance to the present disclosure and as defined above, user-initiated requests at the GUI of the electronic user device are timestamped and the timestamp data is utilized by the server to associate each user action with the value of the incrementally adjusted multiplication factor at the precise moment the interaction occurred. Such a functionality enables the server to process user actions in a temporally consistent manner, even in the presence of network latency, display lag, or client-side timing deviations.

Accordingly, by maintaining a temporal alignment between the server and the electronic user device, the system according to the present disclosure ensures that time-sensitive user decisions are reliably interpreted and executed based on the correct game state. Such a functionality has shown to be of great importance in relation to the present disclosure where the multiplier is dynamically and continuously changing and will as such result in an increased the overall reliability of the gaming system, specifically since it ensures that the multiplier value used to compute game outcomes corresponds exactly to the game state at the time of the user action. Accordingly, the solution as is defined in line with the present disclosure will prevent discrepancies gaming outcome determination and enhance overall system integrity.

Furthermore, the server’s continuous calculation of game outcomes based on user bets and the multiplication factor ensures that the game’s progress and outcomes are directly influenced by user actions and the dynamically changing game environment. Such a continuous interaction loop is designed to keep the gaming experience engaging and responsive to each user’s actions.

Still further, the operational framework of the present disclosure enhances game randomization through sophisticated server-side manipulations of the multiplication factor, significantly diverging from conventional computer-based random number generation methods. Typically, these traditional methods can be less effective for online gaming, where predictability and vulnerability to manipulation pose notable risks to game integrity. The advanced randomization approach adopted here actively counters such deficiencies by ensuring that outcomes are not only unpredictable but also secure from external influences and internal biases.

Such an enhancement in randomness directly influences the likelihood of winning, making the game more appealing while also extending player engagement. The unpredictability achieved by the present disclosure allows for maintaining a secure gaming environment. It effectively shields the game from common security threats that exploit predictable patterns in random number generation, thereby bolstering the overall security posture of the gaming platform.

By implementing a dynamic adjustment of the multiplication factor that possibly may be recalibrated based on real-time gameplay data, the system provides a robust defense against the vulnerabilities associated with static random number generation. Such an approach not only secures the game from potential exploits but also upholds the fairness and integrity of each game round, ensuring that all players have equal and unbiased opportunities to succeed.

In addition to the above, in an embodiment where the online game is a multiplayer online game, the operational scheme of the present disclosure introduces an technical advantage, where user-initiated requests from the multiple electronic user devices may be spaced across different time intervals. Such a created behavior is unlike traditional gaming models where players' actions tend to cluster more tightly around specific game events. By permitting reentry, the system encourages players to exit early with the confidence that they can reenter the game, which naturally disperses the load of incoming requests on the server.

Such a temporal distribution of requests aids in managing server load more efficiently, preventing the spikes in data processing demand that typically occur when multiple players simultaneously interact with the game system. As a result, the server can handle user requests with improved responsiveness and reduced latency, leading to a smoother and more stable gaming experience for all participants. Such a feature may not only enhance player satisfaction by minimizing wait times and system lags but also optimizes the use of server resources.

For reference, within the context of the present disclosure, the term “multiplication factor” should be understood to mean the dynamic numerical value that incrementally adjusts during a game round, influencing the potential payout or outcome as perceived by the player. The multiplication factor can be adjusted upwards or downwards and is preferably adjusted upwards during a game round.

Preferably, the predefined criterion is selected to comprise one or a combination of the previously collected intermediate gaming outcome, an elapsed time from the collection of the intermediate gaming outcome, a calculation comprising the multiplication factor at the re-entry time and the multiplication factor at the intermediate gaming outcome time, and a fixed bet amount.

Such a criterion is carefully chosen to reflect both the state of the game and the actions of the player up to that point. The criterion includes the outcome value that the player had previously collected, which reflects past game performance. Additionally, the time elapsed since that collection is considered, which introduces a temporal dynamic to the decision-making process, influencing the strategic timing of reentry. Furthermore, a calculation that relates the multiplication factor at the time of reentry to that at the time of the intermediate outcome provides a direct link between the player’s current decision point and their previous exit point, offering a quantifiable measure of change in game conditions. Lastly, a fixed bet amount can be used as a criterion, simplifying the decision process for the player and standardizing part of the gameplay experience.

Integrating such criterion into the game mechanics enhances the strategic depth and player engagement. By linking reentry conditions to both the player’s previous outcomes and the evolving game dynamics, players are encouraged to make more informed, strategic decisions based on a comprehensive understanding of the game’s progression. Such an implementation not only increases player involvement and investment in each round but also enhances the overall excitement and challenge of the game. The use of elapsed time and changes in the multiplication factor as criterion ensures that the game remains dynamic and responsive to both player actions and inherent game volatility, maintaining a high level of engagement. These mechanisms also add a layer of fairness and transparency to the game, as players have clear, quantifiable benchmarks to base their decisions on, which supports a more balanced and competitive environment. Furthermore, the incorporation of such a criterion helps to manage the game’s economic balance, ensuring that payouts and player reentries are regulated in a way that maintains the game’s sustainability and integrity.

In accordance with a preferred embodiment of the present disclosure, the duration of the game round is predetermined by the server but undisclosed to the user. Such a configuration means that while the server operates with full knowledge of the timeline, the player interacts with the game under conditions of uncertainty regarding how long the round will last. The predetermined duration is as such suitable for managing the game’s operational logistics and for planning server resource allocation efficiently. By not disclosing this duration to the player, the game maintains an element of unpredictability and suspense, which are essential characteristics of engaging gameplay in crash games where the multiplication factor increases until the round unexpectedly ends.

Setting the game round duration in a concealed manner enhances the strategic complexity and emotional engagement of the game. Players must base their decisions on the game’s current state without knowing exactly how much time remains before the round ends, which simulates a risk-based decision-making environment. Such a mechanism effectively heightens the player’s sense of urgency and excitement, encouraging more dynamic and spontaneous gameplay. Additionally, by controlling the round duration from the server side, the operator can ensure that the game operates within predetermined limits that optimize both network performance and game fairness.

Preferably, the multiplication factor is reset at the end of the game round. The resetting process ensures that every new game round begins under standardized conditions, providing a level playing field for all participants. Furthermore, the reset mechanism is crucial for maintaining the integrity of the game’s structure, ensuring that the escalating dynamics of the multiplication factor, which can significantly influence game outcomes, start afresh for each round. Such an operational measure prevents any residual effects from previous rounds from impacting the new game session, thereby upholding the game’s rules and fairness.

Additionally, by standardizing the starting conditions for each round, the game ensures that all players have an equal opportunity at the outset, regardless of their performance in previous rounds. It also simplifies the game management by allowing the server to apply consistent rules and conditions from one round to the next, which can be essential for the game’s scalability and for reducing complexity in game operation. Moreover, resetting the multiplication factor helps in mitigating any potential gaming strategies that could exploit knowledge of incremental increases from previous rounds, thus preserving the game’s challenge and excitement. The routine reset also aids in regulatory compliance, as it supports the principles of fair gaming practices by providing transparent and equitable conditions for all users each time they play.

Furthermore, the final gaming outcome is preferably set to zero if the game round concludes before receiving the user-initiated request to collect the final gaming outcome. Such an implementation is provided to manage situations where a player might delay their collection attempt, possibly due to distraction or strategic delay, and the round concludes in the interim. The setting of the final outcome to zero acts as a fail-safe that ensures the game progresses without delay and resets appropriately for the next round. It reinforces the necessity for players to make timely decisions within the game’s operational tempo, aligning their actions closely with the evolving game dynamics.

Incorporating such a mechanism into the game design enhances the dynamic and fast-paced nature of the gameplay, requiring players to stay actively engaged and make decisions promptly. It serves to maintain a brisk game flow, reducing the potential for game stalling and ensuring that each game round can commence and conclude within its intended time frame. Additionally, setting the final outcome to zero in such scenarios aids in upholding the game’s integrity, as it prevents any exploitation of system delays or player inactivity, which could otherwise lead to unfair advantages or game balance issues. It also simplifies the resolution of game rounds where player interaction ceases unexpectedly, allowing for a smoother transition to subsequent rounds.

In a preferred embodiment, a rate at which the multiplication factor adjusts is defined by the server. The rate of adjustment for the multiplication factor is a server controllable parameter in managing the pace and dynamics of the game. By controlling this rate, the server ensures that the multiplication factor does not escalate “too quickly”, which allows players sufficient time to make informed decisions based on the changing game conditions. Adjusting the rate of adjustment can also be responsive to network conditions, such as the latency or ”ping” time between the server and the user device. This adaptability helps in synchronizing the game’s visual and interactive elements with the actual gameplay experience of the user, ensuring that the displayed game state accurately reflects the server-side computations.

Controlling the rate of adjustment of the multiplication factor at the server level brings several benefits to the gameplay and overall game management. It ensures that the game remains accessible and fair to players with varying network speeds, as adjustments can be made to accommodate slower connections, thereby maintaining a level playing field. The server’s ability to modify the rate based on real-time data about network conditions means that each player’s experience can be optimized for their particular circumstances, enhancing player satisfaction and reducing frustration related to technical disparities.

Moreover, by managing the pace of the game centrally, the server can effectively prevent scenarios where excessively rapid adjustments in the multiplication factor might lead to unintended game outcomes, such as premature game conclusions or overwhelming player decisions. Such a control helps maintain a balanced and engaging game environment, encourages continuous player participation, and upholds the integrity and reliability of the gaming system. The strategic control over the multiplication factor’s progression also allows for fine-tuning the game’s difficulty and excitement level, aligning it with desired gameplay intensity and operator objectives.

In an embodiment, the method further comprises initiating, by the server, a new game round following the reset of the multiplication factor, wherein the new game round comprises generating a new graphical gaming environment and resetting the multiplication factor to the predefined start value.

Accordingly, in such an embodiment the server is tasked with initiating a new game round immediately after the reset of the multiplication factor from a previous round. Such a process involves generating a fresh graphical gaming environment, which is essential for maintaining player interest and ensuring that each round offers a unique experience. Resetting the multiplication factor to its predefined start value is a crucial step that ensures all players begin the new round under the same conditions, free from any carry-over effects that could potentially advantage or disadvantage any player based on the previous round’s dynamics.

The initiation of a new game round by the server, coupled with the generation of a new graphical environment and resetting the multiplication factor, serves to enhance player engagement by providing a consistent and fair starting point for all participants in each round. Such a consistency is vital for maintaining the game’s integrity and fairness, as it prevents any biases that might arise from residual data or player advantages from earlier gameplay. Moreover, refreshing the gaming environment for each new round helps sustain player interest and engagement, as it prevents the gameplay from becoming monotonous or predictable.

Furthermore, the systematic reset and new round initiation help optimize the game management process, allowing for smoother transitions between rounds and more effective resource utilization on the server side. Such a structured approach ensures that the game can scale efficiently to accommodate a large number of players while maintaining high performance and stability. The clear delineation of game rounds also simplifies compliance with gaming regulations, which often require transparent and fair gaming practices to ensure all players have equal opportunities to win each round.

In a preferred embodiment, the predefined start value of the multiplication factor is selected by the server to be within a predefined range. Such an implementation allows for a controlled variability that is designed to maintain the game’s unpredictability while ensuring that the starting conditions are neither too advantageous nor disadvantageous for any player. The server’s ability to select from within a predetermined range allows it to adapt the game’s difficulty and potential reward structure based on various factors, such as player performance trends, game balance objectives, and overall player engagement metrics.

Setting the start value of the multiplication factor within a predefined range allows the game operator to finely tune the game’s difficulty and excitement levels. By adjusting this factor, the operator can influence how quickly the potential winnings might escalate, thus managing the game’s appeal and challenge. Such adjustments ensure that the game remains engaging for both new and experienced players, by aligning the game dynamics closely with player expectations and previous gaming experiences.

Moreover, the ability to vary the multiplication factor’s start value while keeping it within a controlled range ensures that each game round starts under fair conditions. It prevents scenarios where excessively high or low starting values could skew the game outcomes significantly, thereby supporting equitable gameplay. Additionally, managing the start value within a set range enhances the server’s capacity to respond dynamically to gaming environment changes, ensuring optimal performance and player satisfaction across different playing sessions. In a preferred embodiment the multiplication factor is selected to be equal to one (1).

Preferably, user-initiated requests to reenter the game round is allowed for predefined number of times for the duration of a single game round. Accordingly, the game design permits the user to reenter the game round multiple times, but possibly within a controlled limit set for each round. Such a predefined limit on the number of reentries is established by the server and is designed to balance the player’s ability to engage actively and frequently with the game while maintaining responsible gaming practices.

Limiting the number of times a player can reenter a game round during its duration strategically enhances the gameplay by introducing an element of tactical decision-making. Players must consider not only when but also how often to reenter, adding a layer of strategic planning that can deepen the gaming experience. Such a limitation may also help preserve the competitive fairness of the game, ensuring that all players have equal strategic opportunities without any single player monopolizing the game round through excessive reentries.

Moreover, setting a limit on reentries within a single game round helps to uphold the integrity and sustainability of the gaming environment. It prevents the game mechanics from being overwhelmed by excessive player actions, which can lead to operational inefficiencies and potential delays. By controlling the frequency of reentries, the server can maintain smoother gameplay, reduce the risk of server overload, and ensure that the game remains enjoyable and fair for all participants. These measures are also conducive to promoting responsible gaming behavior, as they discourage impulsive reentry and encourage players to make more considered and deliberate choices.

In some embodiments the server will transmit graphical data that is displayed at a graphical user interface (GUI) displayed at the display screen of the electronic user device. However, to reduce the amount of data that is transmitted between the server and the electronic user device it may as an alternative be possible to form control data (e.g. meta data) at the server that subsequently is transmitted to and used by the control unit for creating the graphical data to be displayed within the GUI at the user device. In some embodiments a bandwidth constrain in the network communication between the server and the user device controls if the server should transmit the graphical data of the control data. This embodiment also ensures that the game is progressing as effectively as possible and with a reduced computational load placed on the server, the network and the user device. Such a GUI may also be arranged to allow the player to directly interact with the server, for example allowing the player to control his/her participation in the game as well as to control a size of the bet placed when participating in the game.

Additionally, it may also be possible to allow the graphical representation to be set differently for different game operators, players or groups of players. The graphical representation may also be dependent on e.g. the geographical location of the players, such as dependent on city, country or continent where the player is located/registered.

Within the context of the present disclosure, it should be understood that it in some embodiments so that it may be possible to allow the server to control if a specific electronic user device is to be allowed to apply the scheme according to the present disclosure. Such control may for example be dependent on a geographical location of the electronic user device. Possibly, the geographical location may be selected from a group comprising a city, a country and a continent.

According to another aspect of the present disclosure there is provided a gaming system comprising a server adapted for real-time communication with an electronic user device via a network connection the electronic user device comprising a display screen provided with a graphical user interface (GUI), wherein the server is further adapted to generate a graphical gaming environment, wherein the graphical gaming environment comprises a visualization of a multiplication factor, and the multiplication factor is incrementally adjusted from a predefined start value over a duration of a game round, transmit information representing the graphical gaming environment to the electronic user device for rendering at the GUI of the electronic user device, receive, via the network connection, a first bet from a user of the electronic user device, wherein the first bet initiates participation in the game round within the generated graphical gaming environment, determine, continuously, an intermediate gaming outcome based on the first bet and a current value of the incrementally adjusted multiplication factor, control the GUI of the electronic user device to enable a user interaction portion within the GUI, receive a user-initiated request at the user interaction portion within the GUI of the electronic user device to collect the intermediate gaming outcome, maintain the visualization of the incrementally adjusted multiplication factor within the GUI of the electronic device following the collection of the intermediate gaming outcome, receive a user-initiated request at the user interaction portion within the GUI of the electronic user device to reenter the game round, wherein a second bet for reentry is determined based on a predefined criterion, receive a user-initiated request at the user interaction portion within the GUI of the electronic user device to collect a final gaming outcome, wherein the final gaming outcome is determined based on the second bet and the current value of the incrementally adjusted multiplication factor, and control the GUI of the electronic user device to visually represent the final gaming outcome, wherein the user-initiated requests at GUI of the electronic user device are timestamped to associate the user-initiated requests with a corresponding value of the incrementally adjusted multiplication factor. This aspect of the present disclosure provides similar advantages and embodiments as discussed above in relation to the previous aspects of the present disclosure.

Preferably, the gaming system is a cloud-based computing system, and the server is a cloud server. Thus, the computing power provided by means of the invention may be distributed between a plurality of servers, and the location of the servers must not be explicitly defined. Advantageous following the use of a cloud-based solution is also the inherent redundancy achieved.

In some embodiments the electronic user devices may be selected to include e.g. a computer (laptop/stationary), a mobile phone, a tablet, a (gaming) consoles or any other gaming device and gambling terminals. The GUI may in some embodiments be allowed to depend on the type of electronic user device.

A computer program product comprising a computer readable medium having stored thereon computer program means for operating a gaming system, the gaming system comprising a server adapted for real-time communication with an electronic user device via a network connection, the electronic user device comprising a display screen provided with a graphical user interface (GUI), wherein the computer program product comprises code for generating, by the server, a graphical gaming environment, wherein the graphical gaming environment comprises a visualization of a multiplication factor, and the multiplication factor is incrementally adjusted from a predefined start value over a duration of a game round, code for transmitting, by the server, information representing the graphical gaming environment to the electronic user device for rendering at the GUI of the electronic user device, code for receiving, by the server via the network connection, a first bet from a user of the electronic user device, wherein the first bet initiates participation in the game round within the generated graphical gaming environment, code for determining, continuously by the server, an intermediate gaming outcome based on the first bet and a current value of the incrementally adjusted multiplication factor, code for controlling, by the server, the GUI of the electronic user device to enable a user interaction portion within the GUI, code for receiving, by the server, a user-initiated request at the user interaction portion within the GUI of the electronic user device to collect the intermediate gaming outcome, code for maintaining, by the server, the visualization of the incrementally adjusted multiplication factor within the GUI of the electronic device following the collection of the intermediate gaming outcome, code for receiving, by the server, a user-initiated request at the user interaction portion within the GUI of the electronic user device to reenter the game round, wherein a second bet for reentry is determined based on a predefined criterion, receiving, by the server, a user-initiated request at the user interaction portion within the GUI of the electronic user device to collect a final gaming outcome, wherein the final gaming outcome is determined based on the second bet and the current value of the incrementally adjusted multiplication factor, and code for controlling, by the server, the GUI of the electronic user device to visually represent the final gaming outcome, wherein the user-initiated requests at GUI of the electronic user device are timestamped to associate the user-initiated requests with a corresponding value of the incrementally adjusted multiplication factor. Also this aspect of the present disclosure provides similar advantages and embodiments as discussed above in relation to the previous aspects of the present disclosure.

The computer program product is typically executed using a computing device comprised with the server, preferably including a microprocessor or any other type of computing device. Similarly, a software executed by the server for operating the gaming system may be stored on a computer readable medium, being any type of memory device, including one of a removable nonvolatile random access memory, a hard disk drive, a floppy disk, a CD-ROM, a DVD-ROM, a USB memory, an SD memory card, or a similar computer readable medium known in the art. Accordingly, operation of the gaming system may be at least partly automated, implemented as e.g. software, hardware and a combination thereof.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 illustrates an exemplary gaming system according to a currently preferred embodiment of the present disclosure;

FIG. 2 provides an exemplary illustration of a typical graphical user interface (GUI) for use in playing a game;

FIG. 3A-3E present an operational flow of the game for collect the gaming outcomes and reentering the game, and

FIG. 4 is a flow chart illustrating the exemplary steps for operating the gaming system as shown in FIG. 1.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness to fully convey the scope of the present disclosure to the skilled addressee. Like reference characters refer to like elements throughout.

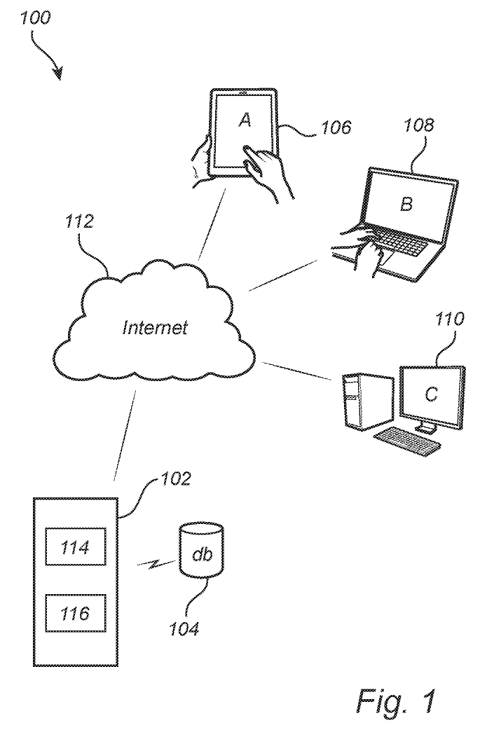

Referring now to the drawings and FIG. 1 in particular, there is depicted a gaming system 100 in which an online game, such as a crash game, may be played according to a currently preferred embodiment of the present disclosure. The system architecture illustrated in FIG. 1 depicts a system environment in which systems, methods, apparatus, computer-readable mediums and data structures consistent with the principles of some embodiments of the present disclosure may be included. It may be appreciated that the components of system 100 may be implemented through any suitable combinations of hardware, software, and/or firmware.

As shown in FIG. 1, system 100 includes at least one server 102 and/or at least one gaming database 104. Server 102 and gaming database 104 may be communicably linked to a plurality of electronic user devices, such as electronic user devices 106, 108, 110, etc. through network 112. The network 112 may be wired or wireless, including for example wired connections like a building LAN, a WAN, an Ethernet network, an IP network, etc., and wireless connections like WLAN, CDMA, GSM, GPRS, 3G mobile communications, 4G mobile communications, 5G mobile communications Bluetooth, infrared, or similar. As such, the network 112 may be locally and/or globally provided.

Network 112 may be implemented as the Internet, or any local or wide area network, either public or private. Network 112 may also be a hardware system physically connecting some or all of the server 102 and electronic user device 106, 108, 110. Electronic user devices 106, 108, 110, typically each operated by a player, may be implemented as any computing devices such as a personal computing device, a server, a server network, handheld computing device, slot machine, other gaming machine in a gaming venue such as a betting terminal, a gaming console, lottery machine, an interface in a virtual environment, etc.

It may be appreciated by one of ordinary skill in the art that while only one server, one gaming database, one network and two client devices are depicted, more or fewer servers, more or fewer gaming databases, more networks and more or fewer client devices and/or other devices may reside within system 100.

In line with the present disclosure the server 102 comprises a plurality of computational modules specifically adapted to perform dedicated tasks when operating at the server 102. One of these modules include a monitoring module 114, another one is a spin rendering module 116. The functionality of the monitoring module 114 and the spin rendering module 116 will be further elaborated below.

The elements inside system 100 may include one or more (micro) processors, purpose-built hardware such as, for example, FPGA, ASIC, etc., software systems and applications, software packages, mechanical and electrical parts, etc. Software packages that may be part of server 102, gaming database 104, electronic user devices 106, 108, 110 and network 112 may be recorded on a computer readable medium such as a memory device, RAM, CD/DVD/USB drives, handheld memory device, etc., and/or may be part of a physical device such as one or more (microprocessors or electro-mechanical systems. Any of server 102, gaming database 104, electronic user devices 106, 108, 110, network 112 and further electronic user device 114 may be fixed systems, mobile systems, portable systems, or cloud systems (as discussed above). FIG. 1 shows only three electronic user devices 106, 108, 110, however it should be understood that a general implementation of the present disclosure comprises a large plurality of electronic user devices, possibly greatly above three, such as 100, 1000, 10000, etc.

Although the various components of FIG. 1 are illustrated as discrete elements, it should be recognized that certain operations of some of the various components may be performed by the same physical device, e.g., by one or more microprocessors or other type of devices.

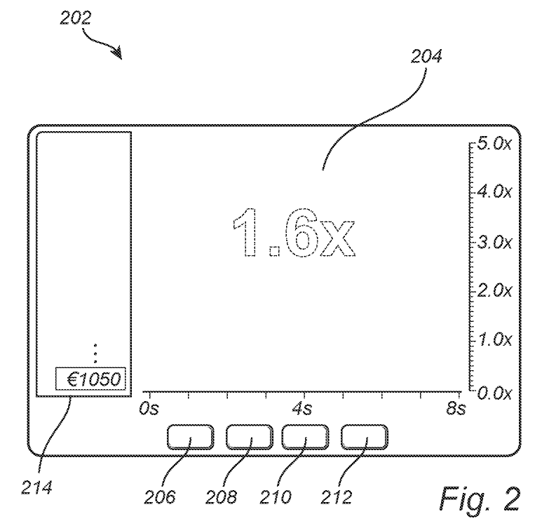

Turning now to FIG. 2 illustrating a graphical user interface (GUI) 202 to be displayed at a display screen of an electronic user device, such as any of the electronic user devices 106, 108, 110, in the illustrated embodiment provided as an application (“app”) or within e.g. a web browser of the portable electronic user device 106 being a tablet. The game to be played at the electronic user device 106 is here shown as an online game, visualized within the GUI 202.

The GUI 202 includes a game portion 204 designed to display an adjusting multiplication factor, preferably an increasing multiplication factor, aligning with the discussions above. Additionally, the GUI features a first button 206 for placing bets, a second button 208 for collecting an intermediate gaming outcome, a third button 210 for reentering the game, and a fourth button 212 for collecting a final gaming outcome. It may in some embodiments be suitable to integrate these functionalities into a single button, depending on the game's current state, to streamline the appearance of the GUI 202. Moreover, the GUI 202 also presents a graphical representation 214 of the currently accumulated account balance, enhancing the user’s awareness of his/her total available funds for further gameplay.

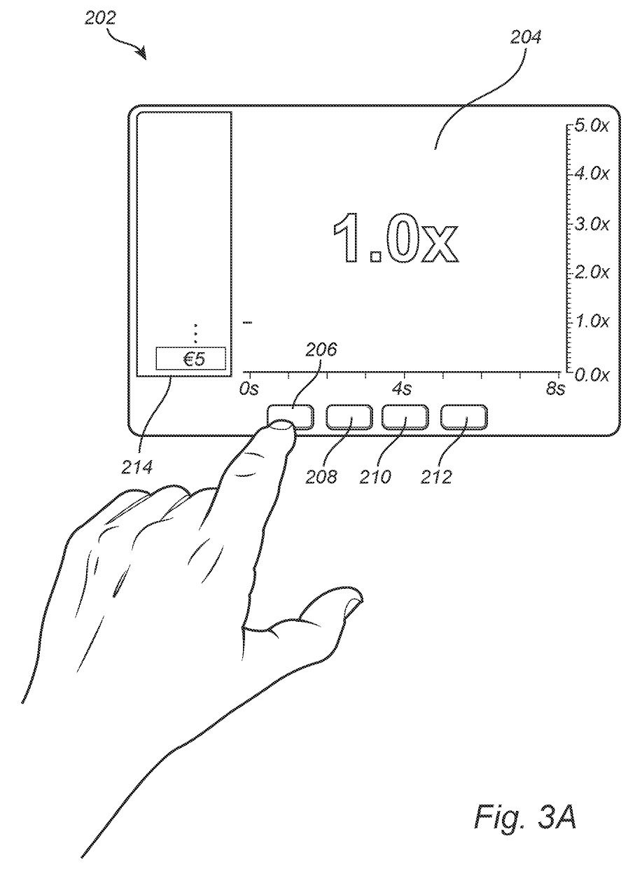

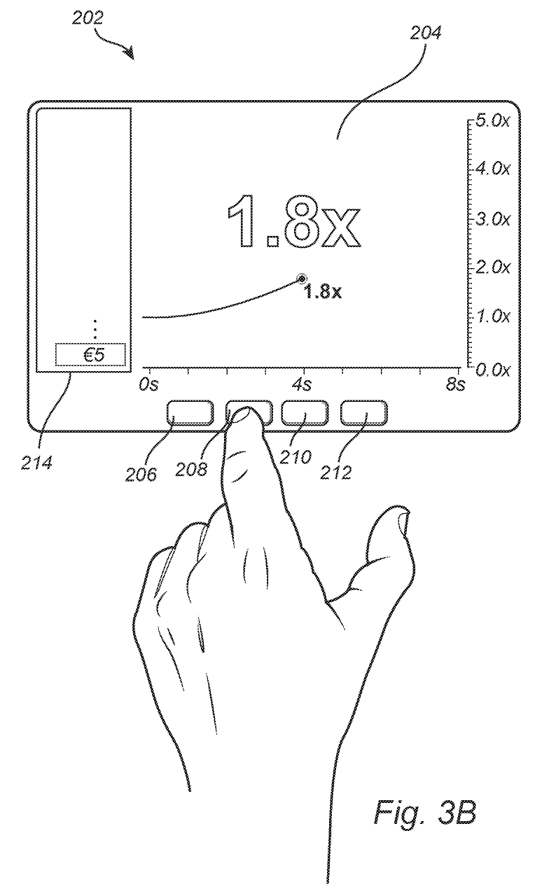

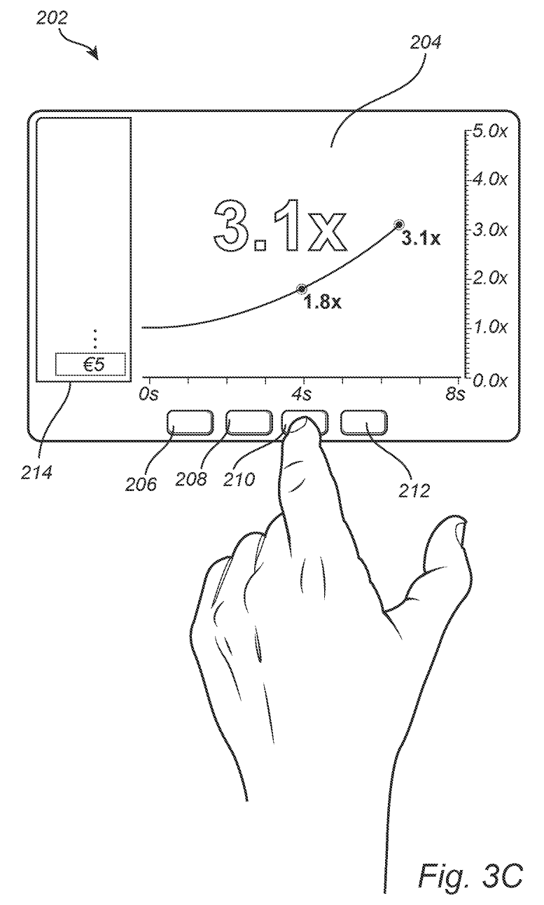

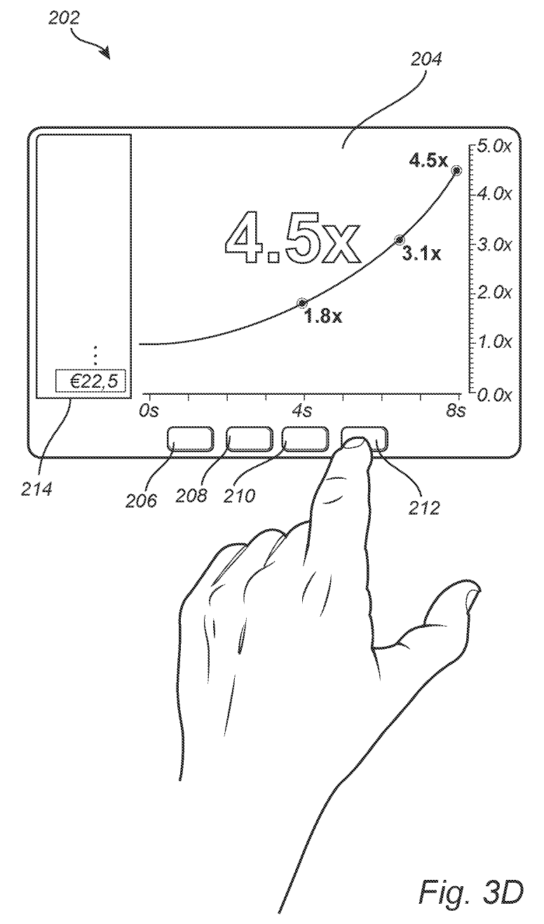

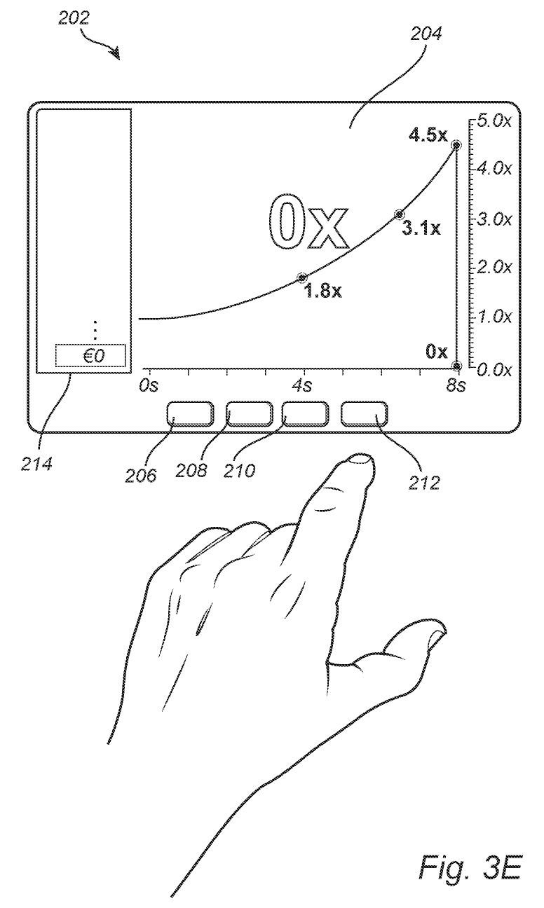

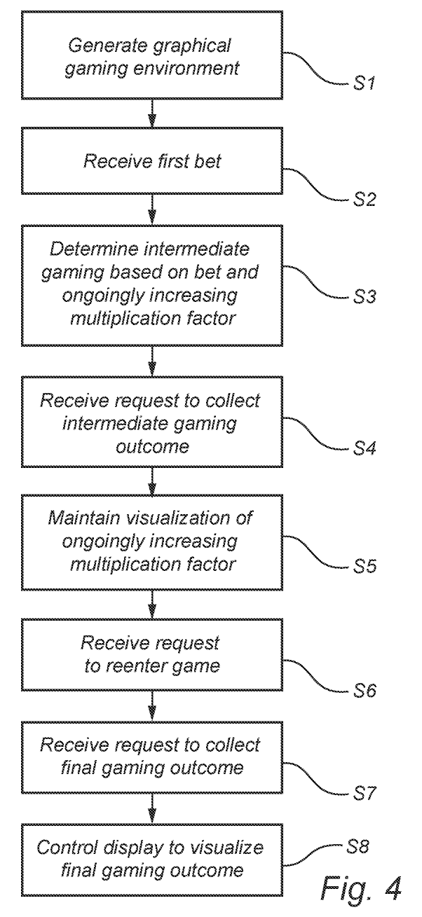

Turning now to FIGS. 3A-3E in conjunction with FIG. 4, illustrating the progression of the GUI 202 during a gameplay. Initially, FIG. 3A illustrates the generation, S1, of the graphical gaming environment within the GUI 202. The player engages with the GUI 202 by utilizing the first button 206 to place a bet. This action is received, S2, by the server 102. Upon the placement of the bet, the visualization of the multiplication factor within the game portion 204 commences its incremental increase from a predefined start value, which in FIG. 3A is shown as one (1).

FIG. 3B depicts subsequent actions in the gameplay sequence. As the game progresses, the multiplication factor within the game portion 204 continues to increase. FIG. 3B here illustrates how the multiplication factor's rise influences the continuous determination of the intermediate gaming outcome. The intermediate outcome, which depends on both the initially placed bet and the dynamically increasing multiplication factor, is continuously determined, S3, and displayed within the gaming portion 204, reflecting its incremental growth alongside the multiplication factor.

At one point in time, the user of the electronic user device 106 decides to collect the accrued intermediate winnings based on the current value of the multiplication factor. This action is facilitated by the user's interaction with the second button 208, through which they submit a request, S4, to the server 102 to collect the intermediate gaming outcome.

FIG. 3C illustrates the continuing gameplay after the user of the electronic user device 106 has collected the intermediate gaming outcome. Despite the collection, the multiplication factor within the game portion 204 of the GUI 202 does not reset but continues to increase, whereby the ongoingly increasing multiplication factor is allowed to be visualized, S5, within the game portion 204 of the GUI 202. The ongoing increase ensures that the game remains dynamic and enticing, even after intermediate collections, and reflects the game's ability to maintain engagement and excitement over its duration.

During this phase, as the multiplication factor escalates, the user of the electronic user device 106 is presented with an opportunity to reengage with the game. Motivated by the increasing potential returns indicated by the rising multiplication factor, the user evaluates the cost for reentry. The cost for reentry is in turn determined based on a combination of the previously collected intermediate gaming outcome and the current value of the multiplication factor. This cost calculation is preferably selected in line with the discussion above, allowing the user to make a strategic decision of whether and when to reenter the game. Upon deciding, the user of electronic user device 106 interacts with the third button 210, where they submit a request, S6, to the server 102 to reenter the game. The server 102, upon receiving the request, processes the reentry based on the calculated cost and the current state of the game.

FIG. 3D presents how the gameplay progresses, where the multiplication factor within the game portion 204 continues its ascent, further intensifying the stakes and potential payouts of the game. At one point in time, the user of electronic user device 106 decides to capitalize on the accumulated potential returns by submitting a request, S7 to the server 102, to collect a “final gaming outcome”. This is in FIG. 3D achieved by the user of electronic user device 106 interacting with the fourth button 212. Upon receiving this request, the server processes the final gaming outcome based on the current multiplication factor and the bets placed.

Subsequently, the server 102 controls, S8, the display of the electronic user device 106 to visualize the final gaming outcome within the game portion 204. Such a visualization not only reflects the total winnings accrued by the player but also serves as a conclusive feedback mechanism, signaling the end of the game round. The multiplication factor will then reset, and a new graphical gaming environment will be generated within the GUI 202 to initiate a new gameplay.

FIG. 3E illustrates an alternative outcome within the gameplay sequence, where the game experiences a “crash”, as known within the field of crash games” before the user of the electronic user device 106 can submit a request to collect the final gaming outcome. As depicted in FIG. 3E, the multiplication factor, which had been escalating within the game portion 204 of the GUI 202, abruptly resets to zero due to the game crash. Such a unexpected turn of events leads to a loss of the potential winnings the user of the electronic user device 106 might have collected had he/she exited the game in time.

Specifically, in this scenario the user of the electronic user device 106 loses his/her total bet, including any possible bet provided for reentry to the game. The GUI 202 displays this sudden crash by visualizing the multiplication factor’s reset, and the absence of any winnings being added to the player’s account. The server 102 processes this outcome by resetting the game environment, preparing for a new game round without awarding any payout to the user. Also here, subsequently a new graphical gaming environment will be generated within the GUI 202 to initiate a new gameplay.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word ”comprising” does not exclude other elements or steps, and the indefinite article ”a” or ”an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

What is claimed is:

1. A computer-implemented method for operating an online game on a gaming system, the gaming system comprising a server configured for real-time communication with an electronic user device via a network connection, the electronic user device comprising a display screen provided with a graphical user interface (GUI), wherein the method comprises:
generating, by the server, a graphical gaming environment, wherein the graphical gaming environment comprises a visualization of a multiplication factor, and the multiplication factor is incrementally adjusted from a predefined start value over a duration of a game round,
transmitting, by the server, information representing the graphical gaming environment to the electronic user device for rendering at the GUI of the electronic user device, receiving, by the server via the network connection, a first bet from a user of the electronic user device, wherein the first bet initiates participation in the game round within the generated graphical gaming environment, determining, continuously by the server, an intermediate gaming outcome based on the first bet and a current value of the incrementally adjusted multiplication factor, controlling, by the server, the GUI of the electronic user device to enable a user interaction portion within the GUI, receiving, by the server, a user-initiated request at the user interaction portion within the GUI of the electronic user device to collect the intermediate gaming outcome, maintaining, by the server, the visualization of the incrementally adjusted multiplication factor within the GUI of the electronic device following the collection of the intermediate gaming outcome, receiving, by the server, a user-initiated request at the user interaction portion within the GUI of the electronic user device to reenter the game round, wherein a second bet for reentry is determined based on a predefined criterion, receiving, by the server, a user-initiated request at the user interaction portion within the GUI of the electronic user device to collect a final gaming outcome, wherein the final gaming outcome is determined based on the second bet and the current value of the incrementally adjusted multiplication factor, and controlling, by the server, the GUI of the electronic user device to visually represent the final gaming outcome, wherein the user-initiated requests at GUI of the electronic user device are timestamped to associate the user-initiated requests with a corresponding value of the incrementally adjusted multiplication factor.

2. The method according to claim 1, wherein the incrementally adjusted multiplication factor is incrementally increased.

3. The method according to claim 1, wherein the predefined criterion is selected to comprise one or a combination of:
the previously collected intermediate gaming outcome,
an elapsed time from the collection of the intermediate gaming outcome,
a calculation comprising the multiplication factor at the re-entry time and the multiplication factor at the intermediate gaming outcome time, and
a fixed bet amount.

4. The method according to claim 1, wherein the duration of the game round is predetermined by the server but undisclosed to the user.

5. The method according to claim 1, wherein the multiplication factor is reset at the end of the game round.

6. The method according to claim 1, wherein the final gaming outcome is set to zero if the game round concludes before receiving the user-initiated request to collect the final gaming outcome.

7. The method according to claim 1, wherein a rate at which the multiplication factor is adjusted is defined by the server.

8. The method according to claim 6, further comprising initiating, by the server, a new game round following the reset of the multiplication factor, wherein the new game round comprises generating a new graphical gaming environment and resetting the multiplication factor to the predefined start value.

9. The method according to claim 1, wherein the predefined start value of the multiplication factor is selected by the server to be within a predefined range.

10. The method according to claim 1, wherein user-initiated requests to reenter the game round is allowed for a predefined number of times for the duration of a single game round.

11. A gaming system comprising a server adapted for real-time communication with an electronic user device via a network connection, the electronic user device comprising a display screen provided with a graphical user interface (GUI), wherein the server is further adapted to:
generate a graphical gaming environment, wherein the graphical gaming environment comprises a visualization of a multiplication factor, and the multiplication factor is incrementally adjusted from a predefined start value over a duration of a game round,
transmit information representing the graphical gaming environment to the electronic user device for rendering at the GUI of the electronic user device,
receive, via the network connection, a first bet from a user of the electronic user device, wherein the first bet initiates participation in the game round within the generated graphical gaming environment,
determine, continuously, an intermediate gaming outcome based on the first bet and a current value of the incrementally adjusted multiplication factor,
control the GUI of the electronic user device to enable a user interaction portion within the GUI,
receive a user-initiated request at the user interaction portion within the GUI of the electronic user device to collect the intermediate gaming outcome,
maintain the visualization of the incrementally adjusted multiplication factor within the GUI of the electronic device following the collection of the intermediate gaming outcome,
receive a user-initiated request at the user interaction portion within the GUI of the electronic user device to reenter the game round, wherein a second bet for reentry is determined based on a predefined criterion,
receive a user-initiated request at the user interaction portion within the GUI of the electronic user device to collect a final gaming outcome, wherein the final gaming outcome is determined based on the second bet and the current value of the incrementally adjusted multiplication factor, and
control the GUI of the electronic user device to visually represent the final gaming outcome,
wherein the user-initiated requests at GUI of the electronic user device are timestamped to associate the user-initiated requests with a corresponding value of the incrementally adjusted multiplication factor.

12. The gaming system according to claim 11, wherein the incrementally adjusted multiplication factor is incrementally increased.

13. The system according to claim 11, wherein the predefined criterion is selected to one or a combination of:
the previously collected intermediate gaming outcome,
an elapsed time from the collection of the intermediate gaming outcome,
a calculation comprising the multiplication factor at the re-entry time and the multiplication factor at the intermediate gaming outcome time, and
a fixed bet amount.

14. The system according to claim 11, wherein the duration of the game round is predetermined by the server but undisclosed to the user.

15. The system according to claim 11, wherein the multiplication factor is reset at the end of the game round.

16. The method according to claim 11, wherein the final gaming outcome is set to zero if the game round concludes before receiving the user-initiated request to collect the final gaming outcome.

17. A computer program product comprising a computer readable medium having stored thereon computer program means for operating a gaming system, the gaming system comprising a server adapted for real-time communication with an electronic user device via a network connection, the electronic user device comprising a display screen provided with a graphical user interface (GUI), wherein the computer program product comprises:
code for generating, by the server, a graphical gaming environment, wherein the graphical gaming environment comprises a visualization of a multiplication factor, and the multiplication factor is incrementally adjusted from a predefined start value over a duration of a game round,
code for transmitting, by the server, information representing the graphical gaming environment to the electronic user device for rendering at the GUI of the electronic user device,
code for receiving, by the server via the network connection, a first bet from a user of the electronic user device, wherein the first bet initiates participation in the game round within the generated graphical gaming environment,
code for determining, continuously by the server, an intermediate gaming outcome based on the first bet and a current value of the incrementally adjusted multiplication factor,
code for controlling, by the server, the GUI of the electronic user device to enable a user interaction portion within the GUI,
code for receiving, by the server, a user-initiated request at the user interaction portion within the GUI of the electronic user device to collect the intermediate gaming outcome,
code for maintaining, by the server, the visualization of the incrementally adjusted multiplication factor within the GUI of the electronic device following the collection of the intermediate gaming outcome,
code for receiving, by the server, a user-initiated request at the user interaction portion within the GUI of the electronic user device to reenter the game round, wherein a second bet for reentry is determined based on a predefined criterion,
receiving, by the server, a user-initiated request at the user interaction portion within the GUI of the electronic user device to collect a final gaming outcome, wherein the final gaming outcome is determined based on the second bet and the current value of the incrementally adjusted multiplication factor, and
code for controlling, by the server, the GUI of the electronic user device to visually represent the final gaming outcome,
wherein the user-initiated requests at GUI of the electronic user device are timestamped to associate the user-initiated requests with a corresponding value of the incrementally adjusted multiplication factor.
